(19) United States
(12) Patent Application Publication
(10) Pub. No.: US 2017/0139503 A1
(43) Pub. Date: May 18, 2017

(54) OPTICALLY TRANSPARENT CONDUCTIVE MATERIAL

(71) Applicant: MITSUBISHI PAPER MILLS LIMITED, Sumida-ku, Tokyo (JP)

(72) Inventor: Takenobu Yoshiki, Sumida-ku (JP)

(21) Appl. No.: 15/316,465

(22) PCT Filed: May 22, 2015
(86) PCT No.: PCT/JP2015/064816

§ 371 Date: Dec. 5, 2016

(30) Foreign Application Priority Data
Jun. 12, 2014 (JP) 2014-121448

(51) Int. Cl. G06F 3/044

(52) U.S. Cl. CPC G06F 3/044; G06F 2203/04103; G06F 2203/04107

(57) ABSTRACT

Provided is an optically transparent conductive material with which the yield in the production of touchscreens is improved can be provided. The optically transparent conductive material has, on a support, optically transparent sensor parts, optically transparent dummy parts, a terminal part, a peripheral wire part electrically connecting the sensor parts and the terminal part, and an earth part, the peripheral wire part having a parallel portion in which adjacent peripheral wires are parallel with each other, the earth part having a parallel portion in which adjacent earth wires are parallel with each other, an inequality A>B being satisfied when A is the smallest interval distance between peripheral wires in the parallel portion of the peripheral wire part and B is the smallest interval distance between earth wires in the parallel portion of the earth part.

### TECHNICAL FIELD

The present invention relates to an optically transparent conductive material preferably used for capacitive touchscreens etc.

### BACKGROUND ART

In electronic devices, such as personal digital assistants (PDAs), laptop computers, office automation equipment, medical equipment, and car navigation systems, touchscreens are widely used as their display screens that also serve as input means.

There are a variety of touchscreens that utilize different position detection technologies, such as optical, ultrasonic, surface capacitive, projected capacitive, and resistive technologies. A resistive touchscreen has a configuration in which an optically transparent conductive material and a glass plate with an optically transparent conductive layer are separated by spacers and face each other so as to function as a touchsensor formed of an optically transparent electrode. A current is applied to the optically transparent conductive material and the voltage of the glass plate with an optically transparent conductive layer is measured. In contrast, a capacitive touchscreen has a basic configuration in which a touchsensor formed of an optically transparent electrode is an optically transparent conductive material having an optically transparent conductive layer provided on a support and there are no movable parts. Capacitive touchscreens are used in various applications due to their high durability and high optically transparency. Further, a touchscreen utilizing projected capacitive technology allows simultaneous multipoint detection, and therefore is widely used for smartphones, tablet PCs, etc.

In a capacitive touchscreen, an optically transparent electrode (optically transparent conductive material) that serves as a touchsensor has a large number of optically transparent conductive parts (optically transparent sensor parts), and therefore allows simultaneous multipoint detection or moving point detection, which is an excellent feature. To take the signals detected by the large number of optically transparent sensor parts to the outside, a peripheral wire part formed of a plurality of peripheral wires is provided between the optically transparent sensor parts and a terminal part provided for passing the signals to the outside, and the peripheral wires electrically connect the sensor parts to the terminal part. In recent years, there is a need to reduce the non-screen area in a liquid crystal display, which means a need to reduce the area occupied by the peripheral wiring part. Therefore, in the peripheral wiring part, it is required to thin each peripheral wire and to narrow intervals between adjacent peripheral wires.

In the production of a touchscreen, an optically transparent conductive material having optically transparent sensor parts and a peripheral wire part is adhered to another optically transparent conductive material, a protective panel, or the like. If the line widths are thin and the intervals between the lines are narrow, a flaw occurring in the production process may cause a line break. A generally adopted countermeasure to solve such a problem is a protective film adhered to the surface of the optically transparent conductive material for the purpose of protecting the sensor parts and the peripheral wire part. The protective film for such a use is prone to be charged, and therefore, when the surface of the optically transparent conductive material is covered with a protective film, the charge can move from the protective film to the sensor parts, and as a result the sensor parts tend to be charged. In addition, when the protective film is removed from the optically transparent conductive material, the sensor parts tend to be charged. When two or more charged sensor parts largely differ in electrical potential, electrical discharge can easily occur between the peripheral wires each connected to individual sensor parts, especially in the cases of narrow intervals between the peripheral wires. Such discharge causes damage to the peripheral wire part (electrostatic destruction), resulting in a significantly reduced yield in the production of touchscreens.

Also, in the production of a capacitive touchscreen, two optically transparent conductive materials are adhered to each other, the adhered optically transparent conductive materials are connected to a FPC (flexible printed circuit board) cable, and the FPC cable is connected to a controller IC. Once all of these are connected in a circuit, the charging phenomenon is eliminated. However, before the stage of connection to the controller IC, for example, in a step of assembly or storage of optically transparent conductive materials not connected to the controller IC, it is extremely difficult to prevent the occurrence of electrical potential difference between charged sensor parts, which difference can cause electrostatic destruction of the peripheral wire part.

Patent Literature 1 describes providing, in the vicinity of a peripheral wire part, a guard line not electrically connected to any optically transparent conductive part in an attempt to prevent damage to peripheral wires from occurring in the process of touchscreen production. Patent Literature 2 describes varying the line widths of peripheral wires in an attempt to prevent metal pattern corrosion and to improve electroless plating uniformity. Patent Literature 3 describes providing auxiliary wires and varying the line widths of peripheral wires and the intervals between adjacent peripheral wires in an attempt to decrease the variation in the electrical capacitance of the peripheral wires.

### CITATION LIST

### Patent Literature

Patent Literature 1: JP 2014-63467 A

Patent Literature 2: JP 2013-206301 A

Patent Literature 3: JP 2009-237673 A

### SUMMARY OF INVENTION

### Technical Problem

The methods described in Patent Literature 1, Patent Literature 2, Patent Literature 3, etc. were employed to prevent the electrostatic destruction of the peripheral wiring part and to improve the yield in the production of touchscreens, but satisfactory results were not obtained. Therefore, an objective of the present invention is to provide an optically transparent conductive material with which the yield in the production of touchscreens can be improved.

### Solution to Problem

The above object of the present invention is basically achieved by an optically transparent conductive material having, on a support, optically transparent sensor parts extending in a first direction, optically transparent dummy parts being arranged alternately with the sensor parts in a second direction perpendicular to the first direction, a terminal part, a peripheral wire part formed of a plurality of peripheral wires electrically connecting the sensor parts and the terminal part, and an earth part formed of a plurality of earth wires not electrically connected to the sensor parts, the peripheral wires having a portion parallel with the adjacent one in the peripheral wire part, the earth wires having a portion parallel with the adjacent one in the earth wire part, an inequality A>B being satisfied when A is the smallest interval distance between peripheral wires in the parallel portion of the peripheral wire part and B is the smallest interval distance between earth wires in the parallel portion of the earth part.

It is preferable that the direction of wires in the peripheral wire parallel portion in the peripheral wire part is the same as the direction of wires in the earth wire parallel portion in the earth part. It is also preferable that the interval distances between peripheral wires in all the parallel portions in the same direction are equal to the smallest interval distance A. It is also preferable that the interval distances between earth wires in all the parallel portions in the same direction are smaller than the smallest interval distance A. It is also preferable that the smallest interval distance B is 10 to 80% relative to the smallest interval distance A. It is also preferable that the line width of each of the earth wires is equal to or greater than the line width of each of the peripheral wires. It is also preferable that the earth part is formed of at least one earth wire connected to the terminal part and two or more earth wires not connected to any other site. It is also preferable that at least one of the earth wires surrounds the optically transparent sensor parts, the optically transparent dummy parts, and the peripheral wire part, leaving the terminal part unsurrounded.

### Advantageous Effects of Invention

According to the present invention, electrical potential difference between sensor parts can be eliminated and thereby electrostatic destruction of a peripheral wire part can be prevented. Therefore, an optically transparent conductive material with which the yield in the production of touchscreens is improved can be provided.

### BRIEF DESCRIPTION OF DRAWINGS

FIG. 1 is a schematic view showing an example of the optically transparent conductive material of the present invention.

FIG. 2 is an enlarged view for illustrating the positional relationship between adjacent peripheral wires.

FIG. 3 is an enlarged view of the peripheral wire part, the terminal part, and the earth part of the optically transparent conductive material shown in FIG. 1.

FIG. 4a is an enlarged view for illustrating the smallest interval distance A between peripheral wires, and FIG. 4b is an enlarged view for illustrating the smallest interval distance B between earth wires.

### DESCRIPTION OF EMBODIMENTS

Hereinafter, the present invention will be illustrated in detail with reference to drawings, but it is needless to say that the present invention is not limited to the embodiments described below and various alterations and modifications may be made without departing from the technical scope of the invention.

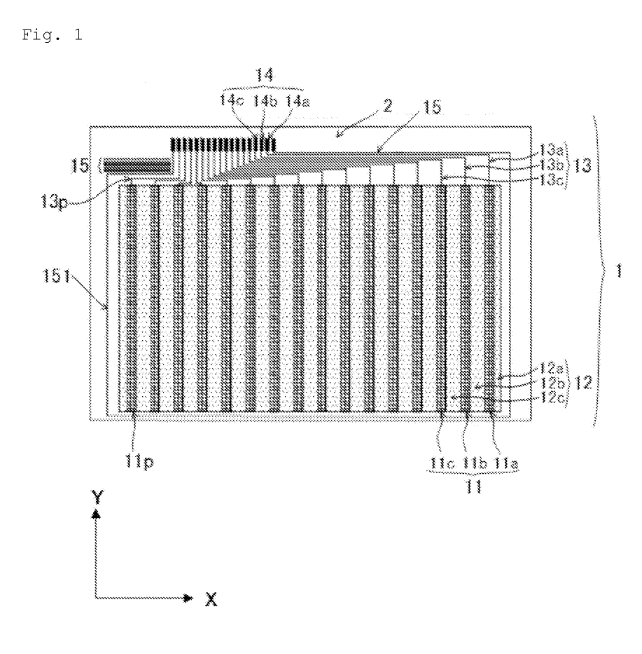

FIG. 1 is a schematic view showing an example of the optically transparent conductive material of the present invention. The optically transparent conductive material 1 has, on a support 2, optically transparent sensor parts 11 extending in a first direction (the y direction in the figure) and optically transparent dummy parts 12 being arranged alternately with the sensor parts 11 in a second direction (the x direction in the figure) perpendicular to the first direction. A plurality of sensor parts 11 (for example, 11a, 11b, 11c . . . , 11p in the figure) are provided, and correspondingly, a plurality of dummy parts 12 (for example, 12a, 12b, and 12c), which are arranged alternately with the sensor parts 11, are provided. In FIG. 1, the areas of the sensor parts 11 and the dummy parts 12 are shown in a checkered pattern and a dotted pattern, respectively for convenient illustration.

A terminal part 14 is a part for electrically connecting the sensor parts 11 to the outside, and formed of a plurality of terminals (for example, 14a, 14b, and 14c in the figure) corresponding to the number of the sensor parts 11 (including a terminal to which the earth wire 151 described later is to be connected). The sensor part 11a is electrically connected, via a peripheral wire part 13a, to a terminal 14a. When an electrical connection to the outside is established through this terminal 14a, the changes in capacitance detected by the sensor part 11 can be captured. The dummy part 12 does not have any electric connection to the terminal part 14.

A peripheral wire part 13 is formed of a plurality of peripheral wires connecting the sensor part 11 and the terminal part 14 (for example, 13a, 13b, 13c . . . , 13p in the figure). The peripheral wires are adjacent to each other and extend, with bendings, in the y direction and in the x direction. As a result, the peripheral wires have a portion parallel with the adjacent one in the peripheral wire part. For example, in FIG. 1, the peripheral wire 13a and the peripheral wire 13b adjacent to each other have parallel portions in two directions, one portion in the y direction and the other portion in the x direction. The direction of the wires in the parallel portion may be the y direction, the x direction, or an oblique direction.

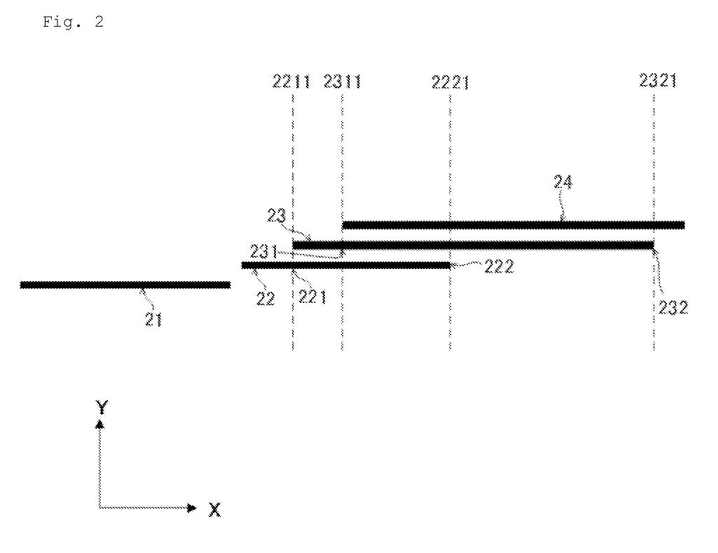

In the present invention, the peripheral wires have, as described above, a portion parallel with the adjacent one in the peripheral wire part 13. This parallel portion will be described below with reference to FIG. 2. FIG. 2 is an enlarged view for illustrating the positional relationship between adjacent peripheral wires.

In FIG. 2, the line segments 21 to 24 all extend in the x direction, and therefore are parallel with each other. Regarding the line segment 22, between the point 221 and the point 222, the perpendicular 2211 and the perpendicular 2221 of the line segment 22 intersect with the line segment 23. In this case, i.e., when there is a portion where the line segment 22 and the line segment 23 extend side by side in the x direction, the line segment 22 and the line segment 23 are regarded as adjacent to each other. Also, regarding the line segment 23, between the point 231 and the point 232, the perpendicular 2311 and the perpendicular 2321 of the line segment 23 intersect with the line segment 24. In this case, i.e., when there is a portion where the line segment 23 and the line segment 24 extend side by side in the x direction, the line segment 23 and the line segment 24 are regarded as adjacent to each other. In contrast, the line segments 21 and 22 do not have any region in which the line segment intersects with such a perpendicular of the other. In this case, i.e., when there is not a portion where the line segment 21 and the line segment 22 extend side by side in the x direction, the line segment 21 and the line segment 22 are not regarded as adjacent to each other. Here, even when two line segments are in parallel and have a portion where the line segments extend side by side in the x direction, if another pattern is present therebetween, the two adjacent line segments are not regarded as adjacent to each other. In FIG. 2, a parallel portion exists between the adjacent line segments 22 and 23, a parallel portion exists between the adjacent line segments 23 and 24, and the three adjacent line segments 22, 23, and 24 are parallel. Accordingly, the three line segments form a parallel portion in the present invention. Thus, the parallel portion in the present invention may be formed of only two adjacent peripheral wires or of three or more adjacent peripheral wires. At least one parallel portion in the peripheral wire part is sufficient. The above-described definition of “adjacent” in the present invention applies to the positional relationship of the earth wires in the earth part.

Next, the earth part will be described. The optically transparent conductive material of the present invention has an earth part 15 not electrically connected to the sensor part 11.

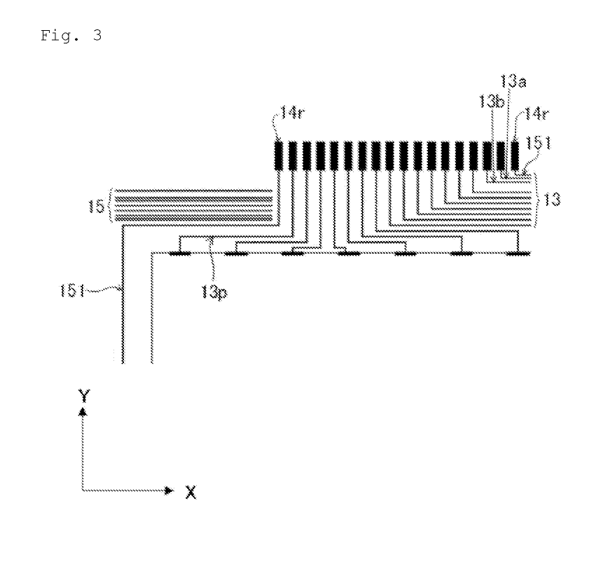

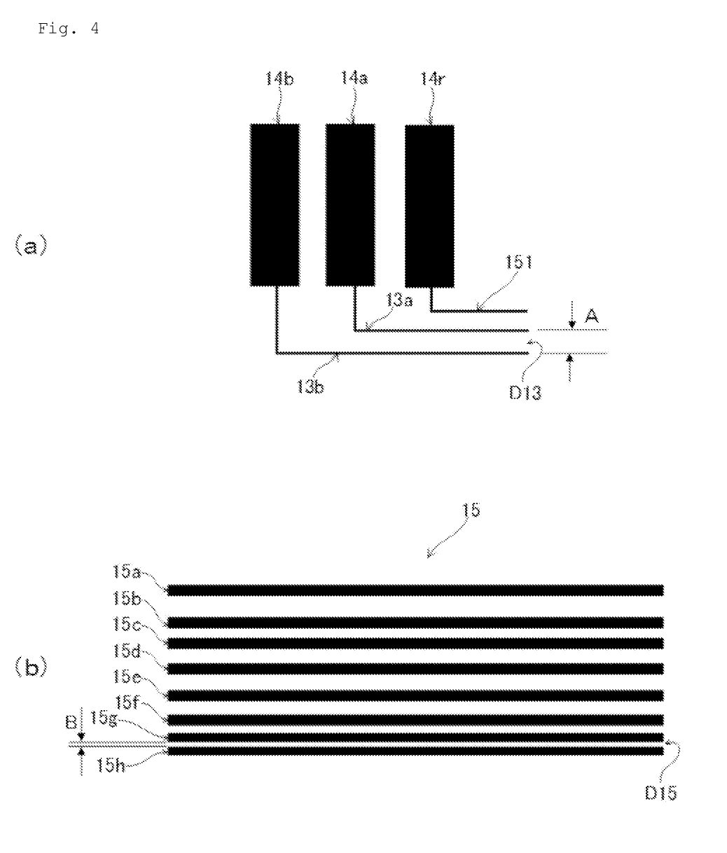

FIG. 3 is an enlarged view of the peripheral wire part, the terminal part, and the earth part of the optically transparent conductive material shown in FIG. 1. In FIG. 3, optically transparent sensor parts 11 and optically transparent dummy parts 12 are omitted. In the present invention, the earth part 15 is not connected to the sensor parts 11. In the present invention, earth wires forming the earth part 15 may be connected to or not connected to the terminal part 14, but it is preferable that the earth part 15 is formed of at least one earth wire connected to the terminal part and a plurality of earth wires not connected to any other site. In this embodiment, the earth part 15 is formed of an earth wire 151 connected to a terminal 14r and a plurality of earth wires 15a, 15b, 15c, 15d, 15e, 15f, 15g, and 15h not connected to any other site, which are shown in FIG. 4b. In FIG. 3, the earth part 15 has a portion in which wires extend in the x direction and are adjacent to and parallel with each other. In the example shown in FIG. 3, all of the adjacent earth wires are parallel, but in the present invention, at least one parallel portion in the earth part is sufficient.

In FIG. 3, the earth wire 151 is connected to the terminal 14r, and at the same time, surrounds the optically transparent sensor parts 11, the optically transparent dummy parts 12, and the peripheral wire part 13, leaving the terminal part 14 unsurrounded (see FIG. 1 described above). It is preferable that at least one of the earth wires thus surrounds the optically transparent sensor parts 11, the optically transparent dummy parts 12, and the peripheral wire part 13, leaving the terminal part 14 unsurrounded. This provides an optically transparent conductive material having a particularly high resistance to electrostatic destruction.

In FIG. 3, the plurality of peripheral wires have parallel portions in two directions, i.e., portions in which wires are parallel in the x direction and the other portions in which wires are parallel in the y direction. Meanwhile, in the parallel portion of the plurality of earth wires, the wires are parallel in the x direction. Therefore, the x direction is common to the direction of the plurality of peripheral wires in their parallel portion and the direction of the plurality of earth wires in their parallel portion. It is preferable that the direction of wires in the peripheral wire parallel portion in the peripheral wire part is the same as the direction of wires in the earth wire parallel portion in the earth part because this provides an optically transparent conductive material having a particularly high resistance to electrostatic destruction.

Next, the smallest interval distance in the present invention will be described with reference to FIG. 3 and FIG. 4.

In FIG. 3, the peripheral wire part 13 is formed of peripheral wires 13a, 13b . . . , and 13p, and the wires are adjacent to and parallel with each other in the x direction in a portion and are adjacent to and parallel with each other in the y direction in another portion. The site where the interval between two adjacent peripheral wires is narrowest (i.e., between peripheral wires 13a and 13b) in said parallel portions is designated as D13 in FIG. 4a. In the present invention, the interval distance of D13, where the interval between the peripheral wires is narrowest, is referred to as the smallest interval distance A. There may be two or more D13 sites, where the interval between two peripheral wires is narrowest. Moreover, the interval distances between peripheral wires in all the parallel portions in a same direction (for example, in FIG. 3, the interval distances between the peripheral wires 13a, 13b . . . , and 13p in portions where the adjacent peripheral wires extend in the same x direction and are parallel with each other), are preferably equal to the smallest interval distance A. This provides an optically transparent conductive material having an excellent resistance to electrostatic destruction. The site where the interval between two adjacent earth wires in FIG. 3 is narrowest is designated as D15 in FIG. 4b. In the present invention, the interval distance of D15, where the interval between the earth wires is narrowest (i.e., between the earth wires 15g and 15h), is referred to as the smallest interval distance B. There may be two or more D15 sites, where the interval between two earth wires is narrowest. In the present invention, the smallest interval distance A between peripheral wires and the smallest interval distance B between earth wires are in the relationship of A>B. When the relationship is satisfied, an optically transparent conductive material of which the yield reduction caused by electrostatic destruction is improved can be obtained. Also, the smallest interval distance B between earth wires is preferably 10 to 80% of the smallest interval distance A between peripheral wires.

In the present invention, the line width of the peripheral wires which form the peripheral wire part is preferably 5 to 200 μm, more preferably 10 to 100 μm. The length of the peripheral wires varies depending the size of the touchscreen, but is usually in the range of 1 to 1000 mm. Meanwhile, the interval distance between adjacent peripheral wires in the peripheral wire part is preferably 5 to 150 μm, more preferably 10 to 70 μm, and particularly preferably 10 to 50 μm. By thus adjusting the line width of the peripheral wires and the interval distance between adjacent peripheral wires, the non-screen area in a liquid crystal display can be reduced. The line width of the earth wires which form the earth part is preferably equal to or greater than the line width of the peripheral wires which form the peripheral wire part. This provides an optically transparent conductive material having an excellent resistance to electrostatic destruction. Also, as described above, the smallest interval distance B between earth wires is smaller than the interval distance A between peripheral wires, and the interval distances between earth wires in all the parallel portions in the same direction (for example, in FIG. 3 and FIG. 4, the interval distances between the earth wires 151, 15a . . . , and 15h in portions where the adjacent earth wires extend in the same x direction and are parallel with each other) are preferably smaller than the smallest interval distance A. Preferably, this requirement is satisfied and the interval distance between earth wires is 5 to 150 μm. More preferably, this requirement is satisfied and the interval distance is 5 to 50 μm. The intervals between adjacent wires in the earth part may be all the same or different. The thickness of the peripheral wires and the earth wires is preferably 0.05 to 10 μm, more preferably 0.05 to 2 μm.

As the support of the optically transparent conductive material of the present invention, plastics, glass, rubber, ceramics, etc. are preferably used. The support in the present invention is preferably an optically transparent support having a total light transmittance of 60% or higher. Among plastics, flexible resin films are preferably used because of excellent ease in handling. Specific examples of the resin films used as the optically transparent support include resin films made of polyesters, such as a polyethylene terephthalate (PET) and a polyethylene naphthalate (PEN), an acrylate resin, an epoxy resin, a fluorine resin, a silicone resin, a diacetate resin, a triacetate resin, a polycarbonate, a polyarylate, a polyvinyl chloride, a polysulfone, a polyether sulfone, a polyimide, a polyamide, a polyolefin, a cyclic polyolefin, etc., and the thickness is preferably 25 to 300 μm. The support may have publicly known layers, such as a physical development nuclei layer, an easily adhering layer, and an adhesive layer.

For the optically transparent sensor parts and the optically transparent dummy parts arranged alternately with the sensor parts in the optically transparent conductive material of the present invention, known optically transparent conductive layers may be used. For example, the optically transparent sensor parts may be formed of an ITO (indium tin oxide) conductive film, and the dummy parts maybe portions that lack the ITO conductive film. Furthermore, in a preferable example, a metal mesh pattern formed of metal thin lines may be used for the optically transparent sensor parts and the optically transparent dummy parts because such a metal mesh pattern has advantages, e.g., higher optically transparency and higher flexibility as compared with ITO conductive films. Preferred examples of the metal used in forming the metal mesh pattern include gold, silver, copper, nickel, aluminum, and composite materials thereof. In the present invention, using the same metal for forming the optically transparent sensor part, the optically transparent dummy part, the terminal part, the peripheral wire part, and the earth part is preferable in terms of productivity because all the parts can be produced at the same time in the same manner.

In the present invention, examples of the method for forming an optically transparent sensor part, an optically transparent dummy part, a terminal part, a peripheral wire part, and an earth part using a metal pattern include known methods, such as a method in which a silver halide photosensitive material is used to obtain a silver image, a method in which non-electrolytic plating or electrolytic plating of the silver image obtained by the aforementioned method is performed, a method in which screen printing with use of a conductive ink is performed, a method in which inkjet printing with use of a conductive ink is performed, a method in which a conductive layer made of a metal, such as copper, is formed by non-electrolytic plating etc., a method in which a metal pattern is obtained by forming a conductive layer by evaporation coating or sputtering, forming a resist film thereon, exposing, developing, etching of the conductive layer, and removing the resist layer, and a method in which a metal pattern is obtained by placing a metal foil, such as a copper foil, making a resist film thereon, exposing, developing, etching of the metal foil, and removing the resist layer. Among them, a silver halide diffusion transfer process is preferably used because a metal mesh pattern forming the optically transparent sensor parts and the optically transparent dummy parts can be easily thinned. Methods using the silver halide diffusion transfer process are described in, for example, JP 2003-77350 A and JP 2005-250169 A. The thickness of the thin lines of the metal mesh pattern produced by these procedures is preferably 0.05 to 5 μm, more preferably 0.1 to 1 μm.

When the optically transparent sensor part and the optically transparent dummy part of the optically transparent conductive material of the present invention have a metal mesh pattern formed of metal thin lines, the metal mesh pattern preferably has a geometric configuration formed of multiple unit lattices arranged in a grid-like manner. Examples of the shape of the unit lattice include triangles, such as an equilateral triangle, an isosceles triangle, and a right triangle; quadrangles, such as a square, a rectangle, a rhombus, a parallelogram, and a trapezoid; n-sided polygons, such as a hexagon, an octagon, a dodecagon, and an icosagon; and a star. One kind of these shapes may be used repeatedly, and alternatively, two or more kinds of these shapes may be used in combination. Among the above, preferred as the shape of the unit lattice area square and a rhombus. In addition, irregular geometric configrations typified by the Voronoi diagram, the Delaunay diagram, the Penrose tiling, etc. are also included in preferred metal mesh pattern shapes in the present invention.

The line width of the metal wire forming the optically transparent sensor part and the optically transparent dummy part is preferably 20 μm or less, more preferably 1 to 10 μm. The repetition interval of the unit lattice is 600 μm or less, more preferably 400 μm or less. The lower limit of the repetition interval of the unit lattice is 50 μm. The aperture ratio of the optically transparent sensor part and the optically transparent dummy part is preferably 85% or more, more preferably 88 to 99%.

The optically transparent dummy parts of the optically transparent conductive material of the present invention are used for the purpose of lowering the visibility of the sensor parts, and the optically transparent dummy parts are not electrically connected to the terminal part. When an ITO conductive film is used for the sensor parts, portions that lack the ITO conductive film may be used as the dummy parts, as described above. In contrast, when the sensor parts are formed of metal thin lines, if the dummy parts are empty, the sensor parts are visually conspicuous. By forming a pattern of metal thin lines in the dummy parts as well, the difference in the appearance between the sensor parts and the dummy parts is reduced and the visibility of the sensor parts can favorably be lowered. However, in order that dummy parts formed of metal thin lines have no conductivity, it is necessary to break the electrical connection by providing at least an insulating part between the dummy parts and the sensor parts. The insulating part can be easily formed by providing the metal thin line with a line break. The length of each line break is preferably 30 μm or less, more preferably 3 to 15 μm, and still more preferably 5 to 12 μm. Preferably, the dummy parts also have a plurality of line breaks therein. By this, an optically transparent conductive material useful as a sensor having an excellent sensitivity can be obtained. For the purpose of lowering the visibility of the sensor parts, the dummy parts are preferably formed of unit lattices having the same shape as that of the unit lattices of the sensor parts. The dummy parts may be formed of broken lattice formed of partially broken unit lattices. The line break may be provided at part of the unit lattice in a perpendicular or oblique direction to the metal thin line forming the unit lattice. The line width of the metal thin line in the dummy part is preferably the same as that of the metal thin line in the sensor part or wider by an equivalent to the area of the line break (s) in the dummy part. The length of each line break in the dummy parts is preferably 30 μm or less, more preferably 3 to 15 μm. The difference in the total light transmittance between the sensor parts and the dummy parts is preferably within ±1%.

In the present invention, the terminal part is connected to a peripheral wire connected to an optically transparent sensor part. When connected to an IC circuit by bonding to a FPC cable or the like, the terminal part passes information on the capacitance received in the sensor part to the IC circuit. The shape of the plurality of the terminals of the terminal part may be a known shape, such as a rectangle, a rectangle with rounded corners, a circle, and an ellipse.

The optically transparent conductive material of the present invention may be provided with publicly known layers, such as a hard coat layer, an antireflection layer, an adhesive layer, and an antiglare layer on the side having an optically transparent sensor part, an optically transparent dummy part and the like or on the other side.

### EXAMPLES

Hereinafter, the present invention will be illustrated in more detail by Examples, but the present invention is not limited thereto and can be embodied in various ways within the scope of the invention.

### <Preparation of Optically Transparent Conductive Material 1>

As a support, a 100-μm-thick polyethylene terephthalate film was used. The total light transmittance of this support was 91%.

Next, in accordance with the following formulation, a physical development nuclei coating liquid was prepared, applied onto the support, and dried to provide a physical development nuclei layer.

### <Preparation of Palladium Sulfide Sol>

| | | | |
|---|---|---|---|
| Liquid A | Palladium chloride | 5 | g |
| | Hydrochloric acid | 40 | mL |
| | Distilled water | 1000 | mL |
| Liquid B | Sodium sulfide | 8.6 | g |
| | Distilled water | 1000 | mL |

Liquid A and Liquid B were mixed with stirring, and after 30 minutes, passed through a column filled up with an ion exchange resin to give a palladium sulfide sol.

### <Preparation of Physical Development Nuclei Coating Liquid>per m² of Silver Halide Photosensitive Material

| | | |
|---|---|---|
| The above-prepared palladium sulfide sol | 0.4 | mg |
| 2 mass % glyoxal aqueous solution | 0.2 | mL |
| Surfactant (S-1) | 4 | mg |
| Polyethylene glycol diglycidyl ether | 50 | mg |
| (Denacol EX-830 made by Nagase Chemtex Corp.) | | |
| 10 mass % polyethyleneimine aqueous solution | 0.5 | mg |
| (SP-200 made by Nippon Shokubai Co., Ltd.; average | | |
| molecular weight: 10,000) | | |

Subsequently, an intermediate layer, a silver halide emulsion layer, and a protective layer, of which the compositions are shown below, were applied in this order (from closest to the support) onto the above physical development nuclei layer, and dried to give a silver halide photosensitive material. The silver halide emulsion was produced by a general double jet mixing method for photographic silver halide emulsions. The silver halide emulsion was prepared using 95 mol % of silver chloride and 5 mol % of silver bromide so as to have an average particle diameter of 0.15 The obtained silver halide emulsion was subjected to gold and sulfur sensitization using sodium thiosulfate and chloroauric acid by the usual method. The silver halide emulsion obtained in this way contained 0.5 g of gelatin per gram of silver.

### <Composition of Intermediate Layer>per m² of Silver Halide Photosensitive Material

| | |
|---|---|
| Gelatin | 0.5 g |
| Surfactant (S-1) | 5 mg |
| Dye 1 | 5 mg |

S-1 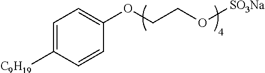
Dye 1

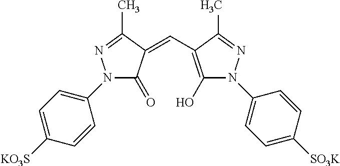

### <Composition of Silver Halide Emulsion Layer>per m² of Silver Halide Photosensitive Material

| Gelatin | 0.5 | g |
|---|---|---|
| Silver halide emulsion | Equivalent of 3.0 g of silver | |
| 1-Phenyl-5-mercaptotetrazole | 3 | mg |
| Surfactant (S-1) | 20 | mg |

### <Composition of Protective Layer>per m² of Silver Halide Photosensitive Material

| | | |
|---|---|---|
| Gelatin | 1 | g |
| Amorphous silica matting agent | 10 | mg |
| (average particle diameter: 3.5 μm) | | |
| Surfactant (S-1) | 10 | mg |

The silver halide photosensitive material obtained as above was brought into close contact with a positive transparent manuscript having the pattern image shown in FIG. 1, and exposure was performed, through a resin filter which cuts off light of 400 nm or less, using a contact printer having a mercury lamp as a light source. In the positive transparent manuscript having the pattern of FIG. 1, the optically transparent sensor part 11 has a mesh pattern formed of a unit graphic as a rhombus of which the line width is 5 μm, the length of each side is 300 μm, and the smaller angle is 60°. The optically transparent dummy part 12 is formed of a unit graphic as a rhombus of which the line width is 5 μm and the shape is the same as that of the sensor part 11, but a line break of 5 μm is provided at the center of the side of the rhombus and a line break of 10 μm is provided at the boundary between the sensor part 11 and the dummy part 12. The difference in the total light transmittance between the sensor part 11 and the dummy part 12 is 0.05%. The peripheral wire part 13, the terminal part 14, and the earth part 15 are all formed of solid line segments. To illustrate the positive transparent manuscript referring to FIG. 3 and FIG. 4, the line widths of the peripheral wires (13a, 13b . . . , 13p) of the peripheral wire part 13 are all 20 μm, and the interval distances of the peripheral wires in portions where the wires are adjacent to and parallel with each other in the x direction are all 20 μm. The interval distance 20 μm of this parallel portion is smaller than the interval distance of any other parallel portion of the peripheral wire part 13, and therefore, the smallest interval distance A is 20 μm. Also, the line widths of the earth wires (151, 15a, 15b, 15c, 15d, 15e, 15f, 15g, 15h) of the earth wire part 15 are all 30 μm, the interval distances of the earth wires in portions where the wires are adjacent to and parallel with each other in the x direction are all 10 μm, and as a result the smallest interval distance B is also 10 μm. (In the following examples as well, an interval distance in the peripheral wire part and the earth part refers to a value in a portion where the wires are adjacent to and parallel with each other in the x direction, and the smallest interval distance A and the smallest interval distance B exist in the parallel portion.)

After the exposed silver halide emulsion layer was immersed in the diffusion transfer developer shown below at 20° C. for 60 seconds, the silver halide emulsion layer, the intermediate layer, and the protective layer were washed off with warm water at 40° C., and a drying process was performed to give the optically transparent conductive material 1. By repeating the above procedure, 100 pieces of the optically transparent conductive material 1 having the metal pattern of FIG. 1 were obtained. The line widths and the interval distances of the metal pattern of the obtained optically transparent conductive material were the same as those of the positive transparent manuscript having the pattern of FIG. 1. Also, the thicknesses of the thin lines of the metal mesh pattern forming the optically transparent sensor part 11 and the optically transparent dummy part 12 and the thicknesses of the metal patterns of the peripheral wires (13a, 13b, 13c . . . , 13p) and the earth wires (151, 15a, 15b, 15c . . . , 15h) measured with a confocal microscope were all 0.1 μm. In the following optically transparent conductive materials 2 to 8 as well, the thickness of each metal pattern measured with a confocal microscope was 0.1 μm.

### <Composition of Diffusion Transfer Developer>

| | | |
|---|---|---|
| Potassium hydroxide | 25 | g |
| Hydroquinone | 18 | g |
| 1-Phenyl-3-pyrazolidone | 2 | g |
| Potassium sulfite | 80 | g |
| N-methylethanolamine | 15 | g |
| Potassium bromide | 1.2 | g |

Water was added to the above ingredients to make the total volume of 1000 mL, and the pH was adjusted to 12.2.

### <Preparation of Optically Transparent Conductive Material 2>

The same procedure was performed as in the preparation of the optically transparent conductive material 1 except that exposure was performed with use of a positive transparent manuscript which had the pattern of FIG. 1 but in which the interval distances between adjacent earth wires (151, 15a, 15b, 15c . . . , 15h) were all changed to 18 μm (as a result, the smallest interval distance B was also 18 μm), and 100 pieces of the optically transparent conductive material 2 were obtained.

### <Preparation of Optically Transparent Conductive Material 3>

The same procedure was performed as in the preparation of the optically transparent conductive material 1 except that exposure was performed with use of a positive transparent manuscript which had the pattern of FIG. 1 but in which the interval distances between adjacent earth wires (151, 15a, 15b, 15c . . . , 15h) were all changed to 25 μm (as a result, the smallest interval distance B was also 25 μm), and 100 pieces of the optically transparent conductive material 3 were obtained.

### <Preparation of Optically Transparent Conductive Material 4>

The same procedure was performed as in the preparation of the optically transparent conductive material 1 except that exposure was performed with use of a positive transparent manuscript which had the pattern of FIG. 1 but in which only the earth wire 151 of the earth part 15 was left and the other earth wires (15a, 15b, 15c . . . , 15h) were removed, and 100 pieces of the optically transparent conductive material 4 were obtained.

### <Preparation of Optically Transparent Conductive Material 5>

The same procedure was performed as in the preparation of the optically transparent conductive material 1 except that exposure was performed with use of a positive transparent manuscript which had the pattern of FIG. 1 but in which the interval distances between adjacent earth wires 15a, 15b, 15c, and 15d were all changed to 25 μm and the interval distances between adjacent earth wires 15d, 15e, 15f, 15g, 15h, and 151 were all changed to 18 μm (as a result, the smallest interval distance B was 18 μm), and 100 pieces of the optically transparent conductive material 5 were obtained.

### <Preparation of Optically Transparent Conductive Material 6>

The same procedure was performed as in the preparation of the optically transparent conductive material 1 except that exposure was performed with use of a positive transparent manuscript which had the pattern of FIG. 1 but in which the interval distance between earth wires 15a and 15b was 10 μm, the interval distance between earth wires 15b and 15c was 14 μm, the interval distance between earth wires 15c and 15d was the interval distance between earth wires 15d and 15e was 22 μm, the interval distance between earth wires 15e and 15f was 26 μm, the interval distance between earth wires 15f and 15g was 30 μm, the interval distance between earth wires 15g and 15h was 34 μm, the interval distance between earth wires 15h and 151 was 38 μm (4 μm increments from 15a to 151; the smallest interval distance B was 10 μm), and 100 pieces of the optically transparent conductive material 6 were obtained.

### <Preparation of Optically Transparent Conductive Material 7>

The same procedure was performed as in the preparation of the optically transparent conductive material 1 except that exposure was performed with use of a positive transparent manuscript which had the pattern of FIG. 1 but in which the interval distance between adjacent peripheral wires 13a and 13b was changed to 15 the interval distances between the other adjacent peripheral wires were changed to 25 μm (as a result, the smallest interval distance A was 15 μm), and the interval distances between adjacent earth wires (151, 15a, 15b, 15c . . . , 15h) were all changed to 20 μm (as a result, the smallest interval distance B was also 20 μm), and 100 pieces of the optically transparent conductive material 7 were obtained.

### <Preparation of Optically Transparent Conductive Material 8>

The same procedure was performed as in the preparation of the optically transparent conductive material 1 except that exposure was performed with use of a positive transparent manuscript which had the pattern of FIG. 1 but in which the interval distance between adjacent peripheral wires 13a and 13b was changed to 15 μm and the interval distances between the other adjacent peripheral wires were changed to 25 μm (as a result, the smallest interval distance A was 15 μm), and 100 pieces of the optically transparent conductive material 8 were obtained.

### Evaluation Test for Rate of Non-defective Products

The obtained optically transparent conductive materials 1 to 8 were evaluated for the rate of non-defective products. In this test, a sensor part (of the sensor part 11), a peripheral wire (of the peripheral wire part 13), and a terminal (of the terminal part 14) which are supposed to be continuous in the positive transparent manuscript having the pattern of FIG. 1 are regarded as a conducting unit. The electrical continuity in each conducting unit and the presence or absence of short circuit between different conducting units were checked with use of a tester (Sain Sonic DT9205A). When all conducting units (each comprising one of the sensor parts 11a to 11p) had appropriate electrical continuity and no short circuit was found, the piece of the optically transparent conductive material was judged as a non-defective product. The number of non-defective products in 100 pieces of the optically transparent conductive material was used as the rate of non-defective products (%).

### Evaluation Test on Electrostatic Destruction

Each of the obtained optically transparent conductive materials 1 to 8 was placed on a cupper plate in such a manner that the side having the optically transparent sensor parts and the optically transparent dummy parts faced away from and did not contact the copper plate. Further, on the silver image, a 100-μm-thick polyethylene terephthalate film was placed, and seasoning was performed in an atmosphere of relative humidity of 50% at 23° C. for one day. After the seasoning, with use of an electrostatic destruction tester (DITO ESD Simulator made by EM TEST with a DM1 tip of the same make), a test on electrostatic discharge destruction was carried out as follows. The earth wire of the electrostatic destruction tester was attached to the copper plate. The tip of the tester was placed above the 100-μm PET film and above the terminal part 14, and then electrostatic discharge was performed at 8 kV once. After the electrostatic discharge, the PET film was removed, and all the lines in the sensor part 11 and all the lines in the peripheral wire part 13 were checked for electrical continuity. A product with no line break was evaluated as Good, a product with only one line break was evaluated as Fair, and a product with two or more line breaks was evaluated as Poor. The results are shown in Table 1.

TABLE 1

| | Rate of non- | | |
|---|---|---|---|
| | defective | Electrostatic | |
| | products | destruction | Note |
| Optically transparent | 99% | Good | Present |
| conductive material 1 | | | invention |
| Optically transparent | 98% | Good | Present |
| conductive material 2 | | | invention |
| Optically transparent | 40% | Poor | Comparative |
| conductive material 3 | | | Example |
| Optically transparent | 30% | Poor | Comparative |
| conductive material 4 | | | Example |
| Optically transparent | 98% | Good | Present |
| conductive material 5 | | | invention |
| Optically transparent | 99% | Good | Present |
| conductive material 6 | | | invention |
| Optically transparent | 20% | Poor | Comparative |
| conductive material 7 | | | Example |
| Optically transparent | 70% | Fair | Present |
| conductive material 8 | | | invention |

As the test results in the above Table 1 clearly show, the present invention provides an optically transparent conductive material less susceptible to electrostatic destruction and with a favorable rate of non-defective products, and thus the yield reduction in the production of touchscreens can be improved.

### <Preparation of Optically Transparent Conductive Material 9>

A positive transparent manuscript which had the pattern of FIG. 1 but in which only the sensor part 11 is drawn in a solid pattern instead of the mesh pattern and there were no patterns in any other parts was prepared. On the ITO surface of an ITO film (300R made by Toyobo Co., Ltd.), a 15-μm-thick dry film resist (SPG102 in the SUNFORT series made by Asahi Chemical Industry Co., Ltd.) was laminated, and exposure was performed using the positive transparent manuscript in close contact and a contact printer having a mercury lamp as a light source, without the use of a resin filter which cuts off light of 400 nm or less. Then, development was performed in a 1 m% aqueous solution of sodium carbonate at 30° C. with shaking for 40 seconds. Subsequently, the ITO film was subjected to etching using an etching solution for ITO (S-CLEAN IS made by Sasaki Chemical Co., LTD.) at ordinary temperature for 120 seconds (before and after the etching process, washing with water was performed), and then a 3 m % aqueous solution of sodium hydroxide at 40° C. was sprayed to strip and remove the dry film resist. Further, washing with water and drying were performed to give a patterned ITO film.

A positive transparent manuscript in which the peripheral wire part 13, the terminal part 14, and the earth part 15 were drawn in a pattern as in FIG. 1 and there were no patterns in any other parts was prepared. In this positive transparent manuscript, the line widths of the peripheral wires (13a, 13b, 13c, . . . , 13p) were all 20 μm, the interval distances between adjacent peripheral wires were all 20 μm (as a result, the smallest interval distance A was also 20 μm), the line widths of the earth wires (151, 15a, 15b, 15c, 15d, 15e, 15f, 15g, 15h) were all 30 μm, and the interval distances between adjacent earth wires were all 10 μm (as a result, the smallest interval distance B was also 10 μm). On the surface of the ITO side of the patterned ITO film obtained as described above, a 15-μm-thick dry film resist (SPG102 in the SUNFORT series made by Asahi Chemical Industry Co., Ltd.) was laminated again, and exposure was performed using the positive transparent manuscript in close contact in such a manner that the positional relationship between the sensor part 11 and the other parts were as shown in FIG. 1 and using a contact printer having a mercury lamp as a light source, without the use of a resin filter which cuts off light of 400 nm or less. Then, development was performed in a 1 m % aqueous solution of sodium carbonate at 30° C. with shaking for 40 seconds. The line widths and the interval distances of the peripheral wire part 13 and the earth part 15 in the resist pattern were the same as those of the positive transparent manuscript. Subsequently, a silver nano particle ink (MU01 made by Mitsubishi Paper Mills Limited) was applied at a rate of 1 g/m² on the basis of solid content and then dried. After immersion in a 30 m % sodium chloride aqueous solution at 40° C. for 1 minute, washing with water and drying were performed. The surface of the dried dry film resist was lightly sanded with an abrasive paper #100, and then a 3 m % aqueous solution of sodium hydroxide at 40° C. was sprayed to strip and remove the dry film resist. Further, washing with water and drying were performed to give the optically transparent conductive material 9. By repeating the above procedure, 100 pieces of the optically transparent conductive material 9 were obtained. The line widths and the interval distances of the peripheral wire part 13 and the earth part 15 in the obtained optically transparent conductive material 9 were the same as those of the positive transparent manuscript. The thicknesses of the peripheral wires (13a, 13b, 13, . . . , 13p) and the earth wires (151, 15a, 15b, 15c, 15d, 15e, 15f, 15g, 15h) measured with a confocal microscope were all 0.1 μm.

### <Optically Transparent Conductive Material 10>

A positive transparent manuscript in which the peripheral wire part 13, the terminal part 14, and only the earth wire 151 (line width: 30 μm) of the earth part 15 were drawn in a pattern as in FIG. 1 and there were no patterns in any other parts was prepared. In the positive transparent manuscript, the line widths of the peripheral wires (13a, 13b, 13c . . . , 13p) were all 20 μm, and the interval distances between the peripheral wires were all 20 μm, (as a result, the smallest interval distance A was also 20 μm). In the same manner as in the preparation of the optically transparent conductive material 9 except for using the thus prepared positive transparent manuscript instead of the above positive transparent manuscript in which the peripheral wire part 13, the terminal part 14, and the earth part 15 were drawn and there were no patterns in any other parts, 100 pieces of the optically transparent conductive material 10 were produced. The line widths and the interval distances of the peripheral wire part 13 and the line width of the earth part 15 in the obtained optically transparent conductive material 10 were the same as those of the positive transparent manuscript. The thicknesses of the peripheral wires (13a, 13b, 13c . . . , 13p) and the earth wire (151) measured with a confocal microscope were all 0.1 μm.

Using the optically transparent conductive materials 9 and 10, tests for the rate of non-defective products and electrostatic destruction were carried out in the same manner as in the tests of the optically transparent conductive materials 1 to 8, and the results shown in Table 2 were obtained.

TABLE 2

| | Rate of non- | | |
|---|---|---|---|
| | defective | Electrostatic | |
| | products | destruction | Note |
| Optically transparent | 90% | Good | Present |
| conductive material 9 | | | invention |
| Optically transparent | 10% | Poor | Comparative |
| conductive material 10 | | | Example |

As the test results in the above Table 2 clearly show, the present invention provides an optically transparent conductive material less susceptible to electrostatic destruction and with a favorable rate of non-defective products, and thus the yield reduction in the production of touchscreens can be improved.

### REFERENCE SIGNS LIST

1 Optically transparent conductive material

2 Support

11, 11a, 11b, 11c, 11p Sensor part

12, 12a, 12b, 12c Dummy part

13 Peripheral wire part

13a, 13b, 13c, 13p Peripheral wire

14 Terminal part

14a, 14b, 14c, 14r Terminal

15 Earth part

151, 15a, 15b, 15c, 15d, Earth wire 15e, 15f, 15g, 15h

21, 22, 23, 24 Line segment

221, 222, 231, 232 Point

2211, 2221, 2311, 2321 Perpendicular

1. An optically transparent conductive material having, on a support, optically transparent sensor parts extending in a first direction, optically transparent dummy parts being arranged alternately with the sensor parts in a second direction perpendicular to the first direction, a terminal part, a peripheral wire part formed of a plurality of peripheral wires electrically connecting the sensor parts and the terminal part, and an earth part formed of a plurality of earth wires not electrically connected to the sensor parts, the peripheral wires having a portion parallel with the adjacent one in the peripheral wire part, the earth wires having a portion parallel with the adjacent one in the earth wire part, an inequality A>B being satisfied when A is the smallest interval distance between peripheral wires in the parallel portion of the peripheral wire part and B is the smallest interval distance between earth wires in the parallel portion of the earth part.

2. The optically transparent conductive material of claim 1, wherein the direction of wires in the peripheral wire parallel portion in the peripheral wire part is the same as the direction of wires in the earth wire parallel portion in the earth part.

3. The optically transparent conductive material of claim 1, wherein the interval distances between peripheral wires in all the parallel portions in the same direction are equal to the smallest interval distance A.

4. The optically transparent conductive material of claim 1, wherein the interval distances between earth wires in all the parallel portions in the same direction are smaller than the smallest interval distance A.

5. The optically transparent conductive material of claim 1, wherein the smallest interval distance B is 10 to 80% relative to the smallest interval distance A.

6. The optically transparent conductive material of claim 1, wherein the line width of each of the earth wires is equal to or greater than the line width of each of the peripheral wires.

7. The optically transparent conductive material of claim 1, wherein the earth part is formed of at least one earth wire connected to the terminal part and a plurality of earth wires not connected to any other site.

8. The optically transparent conductive material of claim 1, wherein at least one of the earth wires surrounds the optically transparent sensor parts, the optically transparent dummy parts, and the peripheral wire part, leaving the terminal part unsurrounded.

9. The optically transparent conductive material of claim 2, wherein the interval distances between peripheral wires in all the parallel portions in the same direction are equal to the smallest interval distance A.

10. The optically transparent conductive material of claim 2, wherein the interval distances between earth wires in all the parallel portions in the same direction are smaller than the smallest interval distance A.

11. The optically transparent conductive material of claim 3, wherein the interval distances between earth wires in all the parallel portions in the same direction are smaller than the smallest interval distance A.

12. The optically transparent conductive material of claim 9, wherein the interval distances between earth wires in all the parallel portions in the same direction are smaller than the smallest interval distance A.

13. The optically transparent conductive material of claim 2, wherein the smallest interval distance B is 10 to 80% relative to the smallest interval distance A.

14. The optically transparent conductive material of claim 3, wherein the smallest interval distance B is 10 to 80% relative to the smallest interval distance A.

15. The optically transparent conductive material of claim 9, wherein the smallest interval distance B is 10 to 80% relative to the smallest interval distance A.

16. The optically transparent conductive material of claim 4, wherein the smallest interval distance B is 10 to 80% relative to the smallest interval distance A.

17. The optically transparent conductive material of claim 10, wherein the smallest interval distance B is 10 to 80% relative to the smallest interval distance A.

18. The optically transparent conductive material of claim 11, wherein the smallest interval distance B is 10 to 80% relative to the smallest interval distance A.

19. The optically transparent conductive material of claim 12, wherein the smallest interval distance B is 10 to 80% relative to the smallest interval distance A.
